(19) United States
(12) Patent Application Publication
(10) Pub. No.: US 2025/0055400 A1
(43) Pub. Date: Feb. 13, 2025

(54) METHOD FOR DRIVING A POWER SUPPLY INVERTER OF A MOTOR COMPRISING AT LEAST TWO WINDINGS UPON A SHORT-CIRCUIT TYPE FAILURE

(71) Applicants: JTEKT EUROPE, Irigny (FR); CONTINENTAL AUTOMOTIVE TECHNOLOGIES GMBH, Hanover (DE)

(72) Inventors: Arnaud BOUCHET, Oullins (FR); Benjamin VEREECKE, Lyon (FR); Daniel GUERRA, Plaisance Du Touch (FR)

(73) Assignees: JTEKT EUROPE, Irigny (FR); CONTINENTAL AUTOMOTIVE TECHNOLOGIES GMBH, Hanover (DE)

(21) Appl. No.: 18/717,551

(22) PCT Filed: Dec. 1, 2022
(86) PCT No.: PCT/FR2022/052206

§ 371 Date: Jun. 7, 2024

(30) Foreign Application Priority Data
Dec. 9, 2021 (FR) FR2113215

(51) Int. Cl. H02P 29/028; B62D 5/04; H02P 25/22; H02P 27/08

(52) U.S. Cl. CPC H02P 29/028; B62D 5/0484; H02P 25/22; H02P 27/08

(57) ABSTRACT

A method for driving an assistance-providing motor of a power-steering system of a vehicle, the assistance-providing motor including a first winding electrically energized by a first inverter, and at least a three-phase second winding electrically energized by a second inverter different from the first inverter, the first winding and the at least a second winding being mechanically coupled to each other, characterized in that it includes, when a malfunction of short-circuit type is detected between a phase of the first winding and a supply or an electric ground of the first inverter: —a determining step; —a measuring step; —a tripping step; —a controlling step.

The invention concerns the field of power steering systems of a vehicle and more particularly a method for driving an electric assist motor of a power steering system of a vehicle, as well as a vehicle implementing such a method.

The purpose of a steering system of a vehicle is to allow a driver to control a trajectory of the vehicle by exerting an effort or a torque on a steering wheel.

A steering system comprises several elements including said steering wheel, a rack, and two wheels each connected to a link.

Traditional power steering systems are known in which the steering wheel is mechanically connected to the rack via a steering column. An electric motor then makes it possible to reduce the effort to be provided by the driver on the steering wheel to turn the wheels of the vehicle.

Steering systems without a mechanical connection, called “steer by wire”, are also known, in which the steering wheel is mechanically decoupled from the rack. In this case, the steering system comprises a first electric motor at the steering wheel and a second electric motor at the rack. The first motor makes it possible to create a resistance at the steering wheel so as to simulate a mechanical connection between the steering wheel and the rack, while the second motor makes it possible to actuate the rack.

Thereafter, the term assist motor designates one of the motors of a traditional or “steer by wire” type power steering system.

The considered assist motor comprises at least two three-phase windings and takes the shape of at least two mechanically connected motors each comprising a three-phase winding or of a motor with at least two windings. Each winding may for example be of the synchronous brushless type, with an excited rotor or with a permanent magnet, powered by three phases designated respectively by U, V and W in the rest of the description.

An inverter contains three electrical lines, each of the parts of the electrical lines in connection with an electrical ground of the inverter will be qualified as “ground side”, or “low side”, and each of the parts of the electrical lines in connection with a power supply of the inverter will be qualified as “power supply side” or “high side”. Each electrical line includes on the ground side a first switching cell of the MOSFET (“Metal Oxide Semi Conductor Field Effect Transistor”) type, also called “low side” and on the power supply side, a second switching cell of the MOSFET type, also called “high side”, according to a diagram known to those skilled in the art.

The phases of a winding of the assist motor are powered by the electrical lines of the inverter. More particularly, each phase of the winding is linked to an electrical line between the ground-side switching cell and the power supply-side switching cell.

The inverter is driven by an electronic control unit which determines a torque to be exerted by the assist motor. A direction of rotation and a speed of a rotor associated with the powered winding are resultants of the exerted torque, the rotor possibly being common to at least two windings.

Upon the operation of the power steering system, a short-circuit type failure may appear between a phase of the winding and an electrical line of the inverter. Generally, this type of failure appears upon a failure of one of the switching cells. A short circuit means an accidental electrical connection between a phase of the winding and an electrical line of the inverter.

The assist motor therefore comprises, after failure, a first winding which is powered by the faulty inverter and a second winding powered by the functional inverter. The faulty inverter itself comprises a faulty switching cell corresponding to the switching cell directly short-circuited, and functional switching cells, that is to say not directly affected by said short circuit.

When a short-circuit type failure is detected in the power steering system, it is known not to drive the faulty inverter which is then positioned in a deactivated state, that is to say a state in which all the functional switching cells are no longer under voltage. The state of the functional switching cells is then in an open state. The functional inverter, meanwhile, is driven normally.

In this configuration, the assist motor is always rotated by the second winding. In other words, the rotor associated with the first winding or the rotor associated with the at least two windings is rotated. There is then created, in the absence of an opening circuit at the phases of the first winding, a current induced by electromotive forces. Said current and the short circuit loop back successively via the short circuit and freewheel diodes present in the functional switching cells of the other electrical lines. This current causes a brake torque reducing the torque performance of the assist motor and causing a significant heating of the functional switching cells of the faulty inverter. The heating may cause one or two other functional switching cells of the failing inverter to fail.

It is then no longer possible to ensure a sufficient operation of the assist motor to guarantee the safety of the occupants of the vehicle despite the presence of an inverter which is still functional.

Thus, a large majority of the steering systems requires embedding an opening circuit at the phases of each winding. However, these opening circuits, generally based on relays, mechanical or static, increase the cost, the volume and the mass of the power steering. In addition, these additional relays increase the risk of hardware failure and therefore decrease the overall reliability of the power steering system.

The object of the invention is to remedy all or part of the aforementioned drawbacks by proposing a method for driving an assist motor of a power steering system intended to be on board a vehicle, the assist motor comprising a first winding electrically powered by a first inverter, said first inverter comprising at least three electrical lines connecting a power supply to an electrical ground of said first inverter, each electrical line being provided with at least one power supply-side switching cell electrically connected to the power supply of said first inverter and with at least one ground-side switching cell electrically connected to the ground of said first inverter, the assist motor also comprises at least a second three-phase winding electrically powered by a second inverter different from the first inverter, the first winding and the at least one second winding being mechanically coupled together, characterized in that it comprises, when a short-circuit type failure is detected between a phase of the first winding and the power supply or the electrical ground of the first inverter:
a determination step in which the electrical line and the side of the switching cell directly affected by the failure is determined,
a measurement step in which at least one parameter of the first inverter is determined,
a trigger step authorizing a control step to be carried out when the at least one parameter reaches a predetermined trigger threshold,
the control step in which at least one of the switching cells of the first inverter positioned on the same side as the switching cell directly affected by the failure, and on one of the at least two other electrical lines, is put in the closed position for a holding time.

The considered assist motor comprises at least two three-phase windings each being powered by a three-phase inverter. The assist motor therefore takes the shape of at least two mechanically linked motors each comprising a three-phase winding or of a motor with at least two windings. In other words, each winding is associated with a different rotor or with a common rotor. Windings mechanically coupled together mean that the rotors of each winding, or the rotor common to each winding, are always rotated by each other. An angular position of the first winding is therefore equal to an angular position of the second winding. Each winding is powered by three phases designated by U, V and W in the description.

The inverter powering the first winding comprises three electrical lines, each electrical line being provided with at least one power supply-side switching cell electrically connected to the power supply of said first inverter and with at least one ground-side switching cell electrically connected to the ground of said first inverter.

A short-circuit type failure puts a phase of the first winding directly in contact with the power supply or the ground of the first inverter.

The short circuit may have two origins:
a direct failure of a switching cell resulting in a short circuit, that is to say that said switching cell is blocked in the closed position;
an electrical contact between a phase of the first winding and the power supply or the ground of the first inverter.

The failure by electrical contact has the same effect as if the switching cell present between said phase and the power supply or the ground of the first inverter were itself short-circuited.

The switching cell directly affected by the failure therefore corresponds to the faulty switching cell or to the switching cell comprised between said phase and the power supply or the ground of the first inverter.

In order to simplify the reading, the switching cell directly affected by the failure will hereafter be called “faulty switching cell” whatever the origin of the short circuit.

The other switching cells of the first inverter are indirectly affected by the short circuit. They may be driven, that is to say they may take a closed or open position. They will subsequently be referred to as the functional switching cells.

The method comprises a determination step, the object of which is to determine precisely how the short circuit is carried out. In other words, the determination step determines the phase of the first winding short-circuited and if it is in contact with the power supply or the ground, that is to say the side, of the first inverter. The determination step therefore makes it possible to characterize the faulty switching cell. The determination step is generally carried out thanks to on-board diagnostics specific to the power steering system itself, or by a software discrimination method based on a measurement of the voltages of the phase and/or a combination of the two.

The purpose of the measurement step is to measure at least one parameter of the first inverter. This measurement may be carried out by any means.

The purpose of the trigger step is to authorize the control step to be carried out only when the measured parameter reaches a predetermined trigger threshold.

Finally, the purpose of the control step is to put in the closed position for a holding time at least one of the functional switching cells of the first inverter positioned on the same side as the faulty switching cell, and on one of the at least two other electrical lines.

In other words, the switching cells put in the closed position depend on the faulty switching cell according to the table below:

TABLE 1

| Faulty switching cell | Switching cells closed upon the control phase | |
|---|---|---|
| Ground-side U | Ground-side V | Ground-side W |
| Ground-side V | Ground-side U | Ground-side W |
| Ground-side W | Ground-side U | Ground-side V |
| Power supply-side U | Power supply-side V | Power supply-side W |
| Power supply-side V | Power supply-side U | Power supply-side W |
| Power supply-side W | Power supply-side U | Power supply-side V |

By closing the functional switching cell in an appropriate manner, it is possible to reduce the heating of said switching cell linked to the induced current when the rotor associated with the first winding or the common rotor is rotated by the second winding. Indeed, the at least one second inverter and the at least one second winding continue to be driven as before. The method does not modify their driving. However, a rotational speed of the rotors of each winding, or of the common rotor, is directly linked to the electromotive forces induced in each winding to within a constant.

The switching cell which is closed upon the control step is subsequently called “driven switching cell”.

When the switching cell is in the open position, the induced current passes through freewheel diodes thereof. The dissipated power is then equal to:

$${P}_{lossdiode} = {V}_{diode} * {I}_{mosfet} \qquad [ Math 1 ]$$

With P_{lossdiode}: the power dissipated in the diode,
V_{diode}: the threshold voltage of the diode, generally equal to 0.6 V,
I_{mosfet}: the intensity passing through the switching cell.

When the driven switching cell is in the closed position, the induced current passes through a driven junction of the switching cell. The power is then equal to:

$${P}_{loss} = {R}_{mosfet} * {I}_{mosfet}^{2} \qquad [ Math 2 ]$$

With Pₗₒₛₛ: the power dissipated in the switching cell,
R_{mosfet}: the electrical resistance of the driven switching cell,
I_{mosfet}: the intensity passing through the switching cell.
By calculation, we find that P_{lossdiode} is much higher than Pₗₒₛₛ.

Thus, by closing the driven switching cell at a certain time, it is possible to significantly reduce the energy dissipated, and therefore the heating of said functional switching cell and thus prevent a possible new failure.

More specifically, the method according to the invention closes the appropriate switching cell upon intensity peaks passing through said switching cell. Thus, the method avoids an overheating, and a failure, of a second switching cell of the first inverter.

The invention may also have one or several of the following characteristics taken alone or in combination.

According to one embodiment, the at least one second inverter comprises at least three electrical lines connecting a power supply to an electrical ground of said at least one second inverter, each electrical line being provided with at least one power supply-side switching cell electrically connected to the power supply of said at least one second inverter and with at least one ground-side switching cell electrically connected to the ground of said at least one second inverter. Thus, the at least one second inverter has a structure identical to the first inverter. The method may then be applied either to the first or to the at least one second inverter.

According to one embodiment, the at least one parameter of the first inverter is measured when only the switching cell directly affected by the failure is in the closed position.

The first inverter is in the deactivated position when all the switching cells apart from the faulty switching cell are in the open position.

According to one embodiment, the at least one determined parameter is chosen from: a voltage of at least one phase of the first winding or of the at least one second winding, a power supply voltage of the first inverter or of the second inverter, an electrical angle of the first winding or of the at least one second winding, and an intensity of at least one phase of the first winding or of the at least one second winding.

When the at least one determined parameter is the voltage of at least one phase of the first winding, the measurement step is carried out when the electrical line associated with the phase is deactivated, independently of the state of the other electrical lines.

According to one embodiment, the predetermined trigger threshold depends at least on the switching cell directly affected by the failure and/or on a direction of rotation of the first winding.

The purpose of the predetermined trigger threshold is to determine from which time the driven switching cell will be put in the closed position. The purpose of the trigger threshold is therefore to put said driven switching cell in the closed position before the intensity peak.

The first winding is a resistive and inductive load. Thus, it is known that the intensity peak of the considered phase is phase shifted relative to the voltage peak of said phase. This phase shift increases with the frequency and therefore with the rotational speed of the assist motor.

According to the at least one measured parameter, it is possible to adapt the trigger threshold so as to close the driven switching cell before the intensity peak.

According to one embodiment, the trigger threshold depends on the switching cell which will be put in the closed position upon the control step.

Several trigger strategies are possible:
in the case where the measured parameter is the voltage of the phases U, V, W: whatever the direction of rotation of the first winding, the trigger threshold is determined in the table below.

TABLE 2

| Faulty | |
|---|---|
| switching cell | Trigger threshold |
| Ground-side | Voltage of the phase U, V or |
| U, V or W | W <= 0 V |
| Power | Voltage of the phase U, V or |
| supply-side | W >= power supply voltage |
| U, V or W | of the first inverter |

in the case where the measured parameter is the electrical angle of the first winding

The method determines to which phase, and therefore to which driven switching cell, corresponds a first conductive phase and a second conductive phase. The driven switching cell corresponding to the first conductive phase is designated in the following by the driven switching cell 1, and the second driven switching cell corresponding to the second conductive phase is designated in the following by the driven switching cell 2.

The trigger threshold is determined according to the direction of rotation of the first winding and of the driven switching cell according to the table below:

TABLE 3

| Direction of rotation | Driven | |
|---|---|---|
| of the first winding | switching cell | Trigger threshold |
| Positive | 1 | Electrical angle >= |
| | | A_{ngleRef1} + A_{ngleOffset1} |
| Negative | 1 | Electrical angle >= |
| | | A_{ngleRef1} − A_{ngleOffset1} |
| Positive | 2 | Electrical angle >= |
| | | A_{ngleRef2} + A_{ngleOffset2} |
| Negative | 2 | Electrical angle >= |
| | | A_{ngleRef2} − A_{ngleOffset2} |

in which:
A_{ngleRef1} and A_{ngleRef2} correspond to the electrical angle for which the voltage peak will be maximum.

According to one embodiment, the values of A_{ngleRef1} and A_{ngleRef2} depend on the rotational speed of the assist motor.

The table below indicates possible values of A_{ngleRef1}, A_{ngleRef2} depending on the location of the failure, the direction of rotation of the first winding and the driven switching cell. This table is given as an example.

TABLE 4

| Location | Direction of | | | | |
|---|---|---|---|---|---|
| of the | rotation of | Driven | | Driven | |
| short- | the first | switching | | switching | |
| circuit | winding | cell 1 | A_{ngleRef1} | cell 2 | A_{ngleRef2} |
| Ground- | Positive | Ground-side V | 240° | Ground-side W | 300° |
| side U | Negative | Ground-side W | 120° | Ground-side V | 60° |
| Ground- | Positive | Ground-side W | 0° | Ground-side U | 60° |
| side V | Negative | Ground-side U | 240° | Ground-side W | 180° |
| Ground- | Positive | Ground-side U | 120° | Ground-side V | 180° |
| side W | Negative | Ground-side V | 0° | Ground-side U | 300° |
| Power | Positive | Power supply- | 60° | Power supply- | 120° |
| supply- | | side V | | side W | |
| side U | Negative | Power supply- | 300° | Power supply- | 240° |
| | | side W | | side V | |
| Power | Positive | Power supply- | 180° | Power supply- | 240° |
| supply- | | side W | | side U | |
| side V | Negative | Power supply- | 60° | Power supply- | 0° |
| | | side U | | side W | |
| Power | Positive | Power supply- | 300° | Power supply- | 0° |
| supply- | | side U | | side V | |
| side W | Negative | Power supply- | 180° | Power supply- | 120° |
| | | side V | | side U | |

A_{ngleOffset1} and A_{ngleOffset2} correspond to an electrical angle offset making it possible in particular to take into account a phase shift between the voltage peak and the current peak.

According to one embodiment, the values of A_{ngleOffset1} and A_{ngleOffset2} may be chosen fixed, such as for example, A_{ngleOffset1}=−30° and A_{ngleOfset2}=0°.

According to one embodiment, the values of A_{ngleOffset1} and A_{ngleOffset2} are dependent on the rotational speed of the assist motor.

According to one embodiment, the holding time corresponds to the time required for the first winding to rotate by a predetermined electrical angle.

The holding time makes it possible to keep the driven switching cell in the closed position. Thus, the holding time must be sufficient for the intensity peak to pass.

According to one embodiment, the holding time corresponds to the time required for the first winding to rotate by an electrical angle of 120°.

According to one embodiment, the holding time depends on the driven switching cell.

According to one embodiment, the holding time is a fixed predetermined value.

According to one embodiment, the holding time corresponds to a control period of the first inverter reduced by a time for carrying out the measurement step and the trigger state.

The first inverter is controlled with a pulse width modulated control (PWM—Pulse Width Modulation).

Thus, the method, and more precisely the steps of measuring, triggering and controlling are carried out at each command period.

According to one embodiment, the measured parameter is the intensity of at least one phase of the first winding, the measurement being carried out by means of at least one shunt positioned directly on the at least one phase.

This measuring means makes it possible to know the current passing through the phase of the first winding regardless of the open or closed position of the functional switching cells. The other measurement solutions such as the estimate from bridge foot measurement, or from an alternative line do not make it possible to obtain a reliable value, especially upon the control step.

According to one embodiment, the holding time corresponds to the time during which the intensity of the at least one phase of the first winding reaches a predetermined holding threshold.

In other words, the control step holds the driven switching cell in the closed position as long as the intensity is greater than the predetermined threshold.

According to one embodiment, the method comprises an activation step authorizing the control step to be carried out when a rotational speed or a rotational frequency of the assist motor reaches a predetermined activation threshold.

Indeed, the induced current increases with the rotational speed of the assist motor. Thus, at low rotational speed, the current induced in the first inverter is not large enough to cause an overheating of the functional switching cells of the first inverter. The induced current must be mainly managed when the rotational speed reaches a minimum threshold.

The method therefore does not need to be implemented when the rotational speed of the assist motor is below the activation threshold.

The invention also concerns any computer program product characterized in that it includes a set of program code instructions which, when executed by one or several processors, configure the processor(s) to implement a method according to the invention.

The invention also relates to a power steering system or a vehicle implementing a method according to the invention.

The invention will be better understood, thanks to the description below, which relates to several embodiments according to the present invention, given by way of non-limiting examples and explained with reference to the appended schematic drawings, in which:

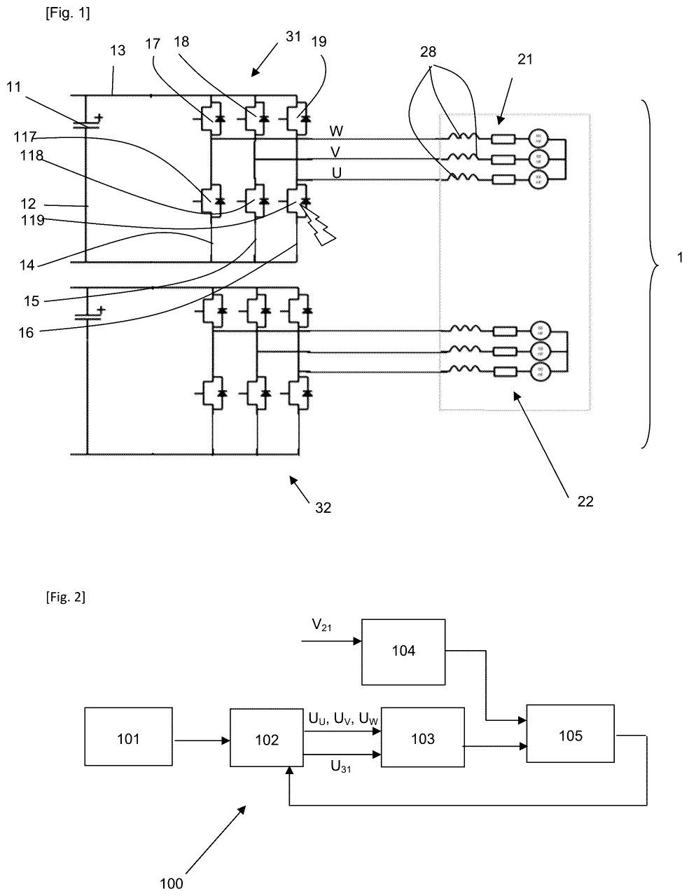

FIG. 1 is a schematic representation of an assist motor and its power supply according to the invention,

FIG. 2 is a schematic representation of the method according to a first embodiment,

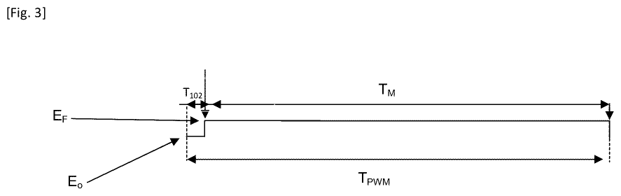

FIG. 3 is a schematic representation of a realization of the method according to a second embodiment,

FIG. 1 illustrates an electrical diagram of an assist motor 1 according to the invention. This comprises a first winding 21 electrically powered by a first inverter 31 and a second winding 22 electrically powered by a second inverter 32.

The first inverter 31 is an electronic apparatus electrically powered by a direct current generator 11 comprising a ground side 12 and a power supply side 13. The first inverter 31 makes it possible to provide a three-phase alternating current.

The first inverter 31 contains three electrical lines 14, 15, 16 disposed in parallel between the ground side 12 and the power supply side 13 of the generator 11. Each electrical line 14, 15, 16 includes a ground-side or “low side” switching cell 117, 118, 119, that is to say a switching cell in connection with the ground side 12 of the generator 11, and a power supply-side or “high side” switching cell 17, 18, 19, that is that is to say a switching cell in connection with the power supply side 13 of the generator 11. The switching cells 17, 18, 19, 117, 118, 119 are of the MOSFET type. The first inverter 31 therefore comprises three ground-side switching cells 117, 118, 119 and three power supply-side switching cells 17, 18, 19.

Each electrical line 14, 15, 16 comprises between the ground-side switching cell 117, 118, 119 and the power supply-side switching cell 17, 18, 19, a phase U, V, W. There are therefore three phases U, V, W powering the first winding 21.

Each phase U, V, W powers a coil 28 of the first winding 21 of the assist motor 1.

In normal operation, electric currents flowing in the phases U, V, W create a rotating magnetic field determining a direction of rotation, a rotational speed and a motor torque of the rotor of the assist motor 1.

A positive direction of rotation and a negative direction are arbitrarily defined. The positive direction corresponds in the rest of the description to the counterclockwise direction.

In the case represented in FIG. 1, the first inverter 31 and the second inverter 32 are identical. However, the second inverter 32 could have a different structure without modifying the invention.

The first winding 21 is mechanically linked to the second winding 22 so that they are subjected to synchronous electromotive forces to within a constant, with a possible reduction ratio.

On the diagram in FIG. 1, the ground-side switching cell 119 connected to the phase U, hereinafter designated by the ground-side switching cell U, is faulty, resulting in a failure of the first inverter 31 of the short-circuit type between the phase U and the ground side 12 of the generator 11. The ground-side switching cell U will also be designated by the faulty switching cell 119. The faulty switching cell 119 is blocked in a closed position.

The second inverter 32 continues to be driven normally and rotates a rotor associated with the second winding 22 and therefore a rotor associated with the first winding 21, said rotors possibly being a single rotor, common to the two windings.

In the presence of a short-circuit type failure, electromotive forces are generated by the rotation of the rotor of the assist motor 1, that is to say of the first winding 21, creating a brake torque at the first winding 21 as well as an overheating of the switching cells of the first inverter 31. This rotation is ensured by the second winding 22 which is functional.

In the example considered below in which the ground-side switching cell U is short-circuited, the ground-side switching cells V and W have a risk of overheating. The ground-side switching cells V and W will therefore be the switching cells to be driven to reduce the risk of additional failure according to table 1 above.

In order to avoid an overheating, the method according to the invention is applied to the first inverter. The second inverter continues to operate normally.

The rest of the description describes several embodiments applied to a failure of the ground-side switching cell U.

As soon as a short circuit is detected by the power steering system, the first inverter 31 is put in a deactivated position, that is to say that the switching cells 118 V and 117 W on the ground side and 19 U, 18 V, 19 W on the power supply side are in the open position.

In all embodiments, the method 100 according to the invention comprises a determination step 101 in which the electrical line 14, 15, 16 and the side of the switching cell directly affected by the failure is determined. In the present case, the determination step 101 indicates that it is the ground-side electrical line U.

In a first embodiment, the method comprises a step of measuring 102 the voltages Uᵤ, Uᵥ, U_{w} of the phases U, V, W of the first inverter 31, when the electrical line associated with the phase U, V, W is deactivated, independently of the state of the other electrical lines, as well as the measurement of the power supply voltage U₃₁ of the first inverter 31.

The trigger step 103 compares the value of the voltages Uᵤ, Uᵥ, U_{w} of the phases U, V, W of the first inverter 31 with a predetermined trigger threshold which depends on the side of the faulty switching cell 119. In our example, the faulty cell 119 is the ground-side switching cell U, the voltage of the phases V and W are therefore compared to 0 V corresponding to the trigger threshold according to table 2 above.

An activation step 104 compares a value of the rotational speed V₂₁ of the rotor of the first winding 21, that is to say of the assist motor 1, with a predetermined activation threshold.

Thus, as long as the predetermined activation threshold and the predetermined trigger threshold are not reached, the control step 105 is not carried out. In other words, as long as the two cumulative conditions are not reached, the driven switching cell remains in a deactivated state.

As soon as the rotational speed V₂₁ of the assist motor 1 becomes greater than the predetermined activation threshold, and the voltage of the phase V is less than 0 V, the control phase 105 may be carried out, that is to say that the ground-side switching cell 118 V is put in the closed position for a holding time. In the same way, as soon as the rotational speed V₂₁ of the assist motor 1 becomes greater than the predetermined activation threshold, and that the voltage of the phase W is less than 0 V, the control phase 105 may be carried out, that is to say that the ground-side switching cell 117 W is put in the closed position during the holding time.

The holding time is determined equal to the time required for the first winding 21 to rotate by an electrical angle of 120°.

When the first winding 21 has carried out an electrical rotation of 120°, the driven switching cell 117, 118 is put in the open position.

It is possible that both ground-side switch cells 118V and 117 W are in the closed position at the same time.

A second embodiment as illustrated in FIG. 3 differs from the method according to the first embodiment only in the determination of the holding time T_{M}. In the second embodiment, the holding time T_{M} is equal to a control period T_{PWM} of the first inverter 31 reduced by a time for carrying out T₁₀₂ the measurement step 102 and the trigger step 103. Thus, at each control period T_{PWM} of the first inverter 31, the steps of measuring 102 and triggering 103 are carried out. Then, if the conditions concerning the activation threshold and the trigger threshold are met, the method carries out the control step 105 putting the driven switching cell 117, 118 in the closed position E_{F} during the holding time T_{M}. Otherwise, the considered switching cell 117, 118 remains in the open position Eₒ during the holding time T_{M}.

Thus at each control period T_{PWM} of the first inverter 31, the position of the ground-side switching cells 118 V and 117 W is likely to be modified.

In a third embodiment, the measurement step determines the electrical angle of the rotor of the first winding 21 and its positive or negative direction of rotation.

The activation step compares a value of the rotational speed of the assist motor 1 with a predetermined activation threshold as for the first and second embodiments.

The trigger step compares the electrical angle measured with the trigger threshold which depends on the location of the short circuit, the driven switching cell 117, 118 and the direction of rotation of the rotor of the first winding 21. The trigger thresholds are for example specified in tables 3 and 4 above.

In the considered case of a failure of the ground-side switching cell 119 U, if the rotor of the first winding 21 rotates in the positive direction with a speed greater than the activation threshold, the trigger threshold is, for the ground-side switching cell 118 V, A_{ngleRef1}+A_{ngleoffset1}=240°+(−30°)=210° and for the ground-side switching cell 117 W, A_{ngleRef2}+A_{ngleoffset2}=300°+(0°)=300°, with A_{ngleoffset1}=−30° and A_{ngleoffset2}=0°.

Thus, when the first winding 21 reaches the electrical angle of 210°, the ground-side switching cell 118 V is put in the closed position, then when the first winding 21 reaches the electrical angle of 300°, the ground-side switching cell 117 W is put in the closed position.

Each of the ground-side 118 V and ground-side 117 switching cells are held closed during a holding time. This may be determined equal to the time required for the first winding 21 to rotate by an electrical angle of 120°.

Thus, when the first winding 21 reaches the electrical angle of A_{ngleRef1}+A_{ngleoffset1}+120°=210°+120°=330°, the ground-side switching cell 118 V is put in the open position, then when the first winding 21 reaches the electrical angle of A_{ngleRef2}+A_{ngleoffset2}+120°=300°+120°=60°, the ground-side switching cell 117 W is put in the open position.

In a fourth embodiment, the measurement step determines an intensity of the phases U, V, W of the first winding 21, the measurement being carried out by means of a shunt positioned directly on each phase.

In this embodiment, the trigger threshold will be a predetermined holding threshold, chosen so as to limit the current flowing through the driven switching cells 117, 118.

The holding time is equal to the time during which the measured intensity is greater than the holding threshold.

In this embodiment, it is not necessary to have an activation step.

Of course, the invention is not limited to the embodiments described and represented in the appended figures. Modifications remain possible, in particular from the point of view of the constitution of the various elements or by substitution of technical equivalents, without departing from the scope of protection of the invention.

1. A method for driving an assist motor of a power steering system intended to be on board a vehicle, the assist motor comprising:
a first three-phase winding, electrically powered by a first inverter, the first inverter comprising at least three electrical lines connecting a power supply to an electrical ground, each electrical line being provided with at least one power supply-side switching cell, electrically connected to the power supply and with at least one ground-side switching cell, electrically connected to the electrical ground, and
at least one second three-phase winding, electrically powered by a second inverter different from the first inverter, the first winding and the at least one second winding being mechanically coupled together,
wherein it comprises, when a short-circuit type failure is detected between a phase of the first winding and the power supply or the electrical ground;
a step of determining the switching cell directly affected by the failure,
a step of measuring at least one parameter of the first inverter, and
a step of triggering a control step when the at least one parameter reaches a trigger threshold,
at least one of the switching cells of the first inverter positioned on the same side as the switching cell directly affected by the failure, and on one of the at least two other electrical lines, being put in the closed position for a holding time during the control step.

2. The driving method according to claim 1, wherein the at least one measured parameter is chosen from: a voltage of at least one phase of the first winding or of the at least one second winding, a power supply voltage of the first inverter or of the second inverter, an electrical angle of the first winding or of the at least one second winding, and an intensity of at least one phase of the first winding or of the at least one second winding.

3. The driving method according to claim 1, wherein the trigger threshold depends on the switching cell directly affected by the failure and/or on a direction of rotation of the first winding.

4. The driving method according to claim 1, wherein the holding time corresponds to the time required for the first winding to rotate by a predetermined electrical angle.

5. The driving method according to claim 1, wherein the holding time is a fixed predetermined value.

6. The driving method according to claim 5, wherein the holding time corresponds to a control period of the first inverter reduced by a time for carrying out the measurement step and the trigger step.

7. The driving method according to claim 1, wherein the measured parameter is an intensity of at least one phase of the first winding, the measurement being carried out by means of at least one shunt positioned directly on the at least one phase.

8. The driving method according to claim 7, wherein the holding time corresponds to the time during which the intensity of the at least one phase of the first winding reaches a holding threshold.

9. The driving method according to claim 1, comprising a step of activating the control step when a rotational speed or a rotational frequency of the assist motor reaches an activation threshold.

10. A computer program product wherein it includes a set of program code instructions which, when executed by one or several processors, configure the processor(s) to implement the method according to claim 1.

11. A vehicle comprising a power steering system comprising an assist motor, the assist motor comprising:
a first three-phase winding, electrically powered by a first inverter, the first inverter comprising at least three electrical lines connecting a power supply to an electrical ground, each electrical line being provided with at least one power supply-side switching cell, electrically connected to the power supply and with at least one ground-side switching cell, electrically connected to the electrical ground, and
at least one three-phase second winding, electrically powered by a second inverter different from the first inverter, the first winding and the at least one second winding being mechanically coupled together,
wherein the power steering system implements the method according to claim 1.
